(19) United States
(12) Patent Application Publication
(10) Pub. No.: US 2014/0282088 A1
(43) Pub. Date: Sep. 18, 2014

(54) METHOD AND APPARATUS FOR SHARING, INTERACTING AND RESPONDING TO ADVERTISING

(71) Applicant: VDOPIA, INC, Fremont, CA (US)

(72) Inventors: Srikanth Kakani, Fremont, CA (US); Chhavi Upadhyay, Fremont, CA (US)

(73) Assignee: Vdopia, Inc, Fremont, CA (US)

(21) Appl. No.: 13/801,285

(22) Filed: Mar. 13, 2013

(51) Int. Cl. G06F 3/0484

(52) U.S. Cl. CPC G06F 3/0484; G06Q 30/0241
USPC 715/753

(57) ABSTRACT

An apparatus and a method allow a user of a mobile device to take actions in conjunction with content being displayed on the mobile device. One such method includes (a) receiving from a content provider the content to be displayed on the mobile device and a configuration script associated with the content that specifies a single-page graphical user interface which (i) displays a number user selectable actions, the user selectable actions being grouped on the graphical user interface under a number of functional categories, with one or more of the user actions each being associated with an application program executable by the mobile device; and (ii) solicits a selection by the user of one of the user selectable actions; (b) displaying the content on a video display of the mobile device; (c) configuring the graphical user interface in accordance with the configuration script; and (e) handling the action as appropriate on the mobile device in response to the selected user action. The content displayed may be one of a video advertisement, a rich-media and an image banner. In one implementation, the configuration script is specified by an XML document.

### BACKGROUND

1. Technical Field

The present disclosure relates to advertising, and combining social media and mobile technologies to create a highly connected response- or action-based mechanism for marketers and advertisers, by creating a easy to use “one-click” interface to execute complex actions.

2. Discussion of the Related Art

Advertising that is delivered to a “smart” mobile device (e.g., a “smart” mobile telephone) has grown in leaps and bounds over the last decade. Initially, i.e., at the end of the 20th century, such advertising is presented in text form. More recently, advertising presented in video form has become quite popular and has grown continuously since video advertisement first appeared on the scene. Contemporaneously, i.e., at least over the past 4-5 years, social networking and collaboration technologies have become major applications of the internet. Such technologies, together with the “smart” mobile devices (e.g., iPhones), provide unique opportunities for video advertising. With a smart mobile device, advertisements can communicate very effectively with their target audience.

### SUMMARY

According to some embodiments, a method allows a user of a mobile device to take actions in conjunction with content being displayed on the mobile device. One such method includes (a) receiving from a content provider the content to be displayed on the mobile device and a configuration script associated with the content that specifies a single-page graphical user interface which (i) displays a number user selectable actions, the user selectable actions being grouped on the graphical user interface under a number of functional categories, with one or more of the user actions each being associated with an application program executable by the mobile device; and (ii) solicits a selection by the user of one of the user selectable actions; (b) displaying the content on a video display of the mobile device; (c) configuring the graphical user interface in accordance with the configuration script; and (e) handling the action as appropriate on the mobile device in response to the selected user action. The content displayed may be one of a video advertisement, a rich-media and an image banner. In one implementation, the configuration script is specified by an XML document.

According to some embodiments, when execution of the application program associated with the selected user action requires providing information as input to the application program, the graphical user interface gathers the information from the mobile device and configures the information as input data to the application program. The information so configured includes information pre-filled emails, pre-filled forms, and pre-populated map searches.

In some embodiments, the selectable user actions are grouped according functional categories which may be any one or more of (a) sharing the content with a second user; (b) responding to the content provider, and (3) interacting content provider's content as specified in the configuration script.

Embodiments disclosed herein may combine the diverse communication capabilities of a smart mobile device (e.g., instant mailing, texting, and voice calls) with powerful social networking applications (e.g., twitter and Facebook) to deliver new interaction possibilities for a video advertiser with its targeted users and among the targeted users.

The disclosed embodiments are better understood upon consideration of the detailed description below in conjunction with the accompanying drawings.

### BRIEF DESCRIPTION OF THE DRAWINGS

FIGS. 1a and 1b are screen shots of interactive screens presented to two smart mobile devices, in accordance with some embodiments.

FIG. 2 is a diagram illustrating a mobile device in communication with a content provider, consistent with some embodiments.

FIG. 3 is a diagram illustrating a mobile device, consistent with some embodiments.

FIG. 4 is a flowchart illustrating a method for allowing a user of a mobile device to take actions in conjunction with content displayed on the mobile device, consistent with some embodiments.

### DETAILED DESCRIPTION

Using caching and near-instant playback techniques, very high quality video advertisement can now be delivered to a smart mobile device and displayed with little latency. As used herein, near-instant playback technique refers to a technique that minimizes latency in playback utilizing, for example, accelerated buffering (i.e., sending data to a buffer at a multiple of the playback data rate). According to some embodiments, as soon as the video stream ends (e.g., either by skipping or at the end of a normal playback), a user is presented an interactive screen that allows the user to take action with respect to the video advertisement that is just played. FIGS. 1a and 1b are screen shots of interactive screens presented to two different smart mobile devices, in accordance with some embodiments.

As shown in each of FIGS. 1a and 1b, each interactive screen displays on a touch-sensitive screen a number of radio buttons, logos or icons organized for selection by a user of the mobile device. In some embodiments, the icons are organized according to various functional categories for which meaningful actions that are related to the video advertising may be provided. In some instances, selection of an icon activates one or more applications to accomplish the desired actions. In FIGS. 1a and 1b, the functional categories are indicated by the labels “Share”, “Respond” and “Interact.” Under a functional category a number of logos or icons may be provided, an icon representing a specific action that can be taken, or a particular application program that can be invoked. As shown in FIGS. 1a and 1b, each icon may be a 60×60 pixel image which indicates the function associated with the icon. As shown in FIGS. 1a and 1b, the icons are displayed in a 3×3 icon matrix, although each functional category may have more than three applications and thus more than three icons associated with it. In such a design, for example, the touch screen may be made responsive to a user's finger flick gesture or a sliding gesture, which would be interpreted as a command by the user to scroll the icons within that functional category (i.e., to display one or more previously hidden icons, while hiding the same number of presently shown icons) in the direction of the gesture.

Except for a few actions, selection of each icon invokes execution of an associated application. One advantage of this approach is that the desired action can be initiated using no more than a few selection gestures or “clicks”, and thus is particularly efficient for a mobile device in which achieving input economy is particularly important. For example, as shown in the “Share” functional category of FIGS. 1a and 1b, icons are provided to allow the user to share information regarding the advertising with other users through the supported social network applications, such as Facebook, LinkedIn, and Twitter. Other possible applications include applications that invoke an email client or a text messaging utility. Similarly, in the “Respond” category of FIGS. 1a and 1b, the user can respond to the advertiser through applications or capabilities that are present on the mobile device, such as voice telephone calls, email, text messaging and other communication utilities, including various innovative “one-click” type methods. For the “Interact” functional category, as shown in FIGS. 1a and 1b, the user is provided icons that enable actions including replaying the advertisement, opening a document that provides additional information about the subject matter of the advertisement (“learn more”), and invoking a map utility to display the geographical location of the advertiser.

To display the share-respond-interact page, at the end of playing the video stream sent by the advertising content server, the server sends to the client (e.g., a media player client) a configuration script using the XML format. After determining the network and device types, the client executes the XML configuration script, which directs it to display the functional categories and the icons representing the supported functions or applications. Where the response requires providing information as input to an associated application program (e.g., selectable options to an application program), the client also configures each option based on its stored information (e.g., pre-filled emails, pre-filled forms, pre-populated map searches relating to advertising that has just been displayed). An example of the XML script is shown below:

The user is now able to share, respond and interact with the advertising with the minimal interaction steps and without having to navigate through multiple selection menus.

FIG. 2 is a block diagram of a networked system 200, consistent with some embodiments. System 200 includes a mobile device 202 and an advertising content provider server 206 in communication over a network 208. Network 208, in one embodiment, may be implemented as a single network or a combination of multiple networks. For example, in various embodiments, network 208 may include the Internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet.

Mobile device 202, in one embodiment, may be implemented using any appropriate combination of hardware and/or software configured for wired and/or wireless communication over network 208. For example, mobile device 202 may be implemented as a wireless telephone (e.g., smart phone), tablet, personal digital assistant (PDA), notebook computer, and/or various other generally known types of wired and/or wireless mobile computing devices. Consistent with some embodiments, client mobile device 202 may include any appropriate combination of hardware and/or software having one or more processors and capable of reading instructions stored on a non-transitory machine-readable medium for execution by the one or more processors. Consistent with some embodiments, client mobile device 202 includes a machine-readable medium, such as a memory (not shown) that includes instructions for execution by one or more processors (not shown) for causing client mobile device 202 to perform specific tasks. For example, such instructions may include displaying advertising content through a media client player application 212, and sharing, responding, and interacting with the advertising content using other applications 214 by user 216 with minimal interaction steps and without having to navigate through multiple selection menus. Applications or “apps” 212 and 214 may be stored in a memory of mobile device 202 and executed by one or more processors executing in mobile device 202. Some common forms of machine-readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which one or more processors or computer is adapted to read.

As discussed above, mobile device 202 may be a mobile device such as a smartphone such as an iPhone™ or other mobile device running the iOS™ operating system, the Android™ operating system, a BlackBerry™ operating system, Windows® Phone operating system, or webOS™. Mobile device 202 may also be a tablet computer, such as an iPad™ or other tablet computer running one of the aforementioned operating systems.

Advertising content provider server 206 according to some embodiments, may be maintained by an online advertising content provider, which may provide advertising content display on mobile device 202 and for presentation to user 216. Advertising content provider server 206 may include advertising content 222, which may be adapted to be presented to user 216 on mobile device 202 over network 208. Advertising content provider server 206 may be configured to generate a configuration script 224, that may be provided to mobile device 202 over network 208. Configuration script 224 may be used to configure a graphical user interface (GUI) of media player client application 212 and/or mobile device 202 to display a number of user selectable actions that are grouped on the GUI under a number of functional categories, with one or more of the user actions each being associated with an application program executable by the mobile device, and solicit a selection of one of the user selectable actions. Configuration script 224 may also, when executed on mobile device 202, obtain information about mobile device 202. According to some embodiments, configuration script 224 may be an Extendable Markup Language (XML) script, such as described above.

FIG. 3 is a diagram illustrating mobile device 202. As shown in FIG. 3, mobile device 202 includes a network interface component (NIC) 302 configured for communication with a network such as network 208 shown in FIG. 2. Consistent with some embodiments, NIC 302 includes a wireless communication component, such as a wireless broadband component, a wireless satellite component, or various other types of wireless communication components including radio frequency (RF), microwave frequency (MWF), and/or infrared (IR) components configured for communication with network 108. Consistent with other embodiments, NIC 302 may be configured to interface with a coaxial cable, a fiber optic cable, a digital subscriber line (DSL) modem, a public switched telephone network (PSTN) modem, an Ethernet device, and/or various other types of wired and/or wireless network communication devices adapted for communication with network 208.

Consistent with some embodiments, mobile device 302 includes a system bus 304 for interconnecting various components within mobile device 302 and communication information between the various components. Such components include a processing component 306, which may be one or more processors, micro-controllers, or digital signal processors (DSP), a system memory component 308, which may correspond to random access memory (RAM), an internal memory component 310, which may correspond to read-only memory (ROM), and an external or static memory 312, which may correspond to optical, magnetic, or solid-state memories. Consistent with some embodiments, mobile device 302 further includes a display component 314 for displaying information to a user 216 of mobile device 202. Display component 314 may be an liquid crystal display (LCD) screen, an organic light emitting diode (OLED) screen (including active matrix AMOLED screens), an LED screen, a plasma display, or a cathode ray tube (CRT) display. Mobile device 202 may also include an input component 316, allowing for a user 216 of mobile device 202 to input information to mobile device 202. Such information could include selecting options displayed on the screens shown in FIGS. 1a and 1b. An input component 216 may include, for example, a keyboard or key pad, whether physical or virtual. Mobile device 202 may further include a navigation control component 318, configured to allow a user to navigate along display component 314. Consistent with some embodiments, navigation control component 318 may be a mouse, a trackball, or other such device. Moreover, if mobile device 202 includes a touch screen, display component 314, input component 316, and navigation control 318 may be a single integrated component, such as a capacitive sensor-based touch screen.

Consistent with some embodiments, mobile device 202 may include a location component 320 for determining a location of mobile device 202. In some embodiments, location component 320 may correspond to a GPS transceiver. In other embodiments, location component 320 may be configured to determine a location of mobile device 202 by using an internet protocol (IP) address lookup, or by triangulating a position based on nearby mobile communications towers. Location component 320 may be further configured to store a user-defined location in any of system memory 308, internal memory 310, and/or external memory 312 that can be transmitted to a third party for the purpose of identifying a location of mobile device 202.

Mobile device 202 may perform specific operations by processing component 306 executing one or more sequences of instructions contained in system memory component 308, internal memory component 310, and/or external or static memory 312. In other embodiments, hard-wired circuitry may be used in place of or in combination with software instructions to implement the present disclosure. Logic may be encoded in a computer readable medium, which may refer to any medium that participates in providing instructions to processing component 306 for execution. Such a medium may take many forms, including but not limited to, non-volatile media, volatile media, and transmission media. The medium may correspond to any of system memory 308, internal memory 310 and/or external or static memory 312. Consistent with some embodiments, the computer readable medium is non-transitory. In various implementations, non-volatile media include optical or magnetic disks, volatile media includes dynamic memory, and transmission media includes coaxial cables, copper wire, and fiber optics, including wires that comprise system bus 304. According to some embodiments, transmission media may take the form of acoustic or light waves, such as those generated during radio wave and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by mobile device 202. In various other embodiments of the present disclosure, a plurality of computing systems 200 coupled by a communication link 322 to network 208 (e.g., such as a LAN, WLAN, PTSN, and/or various other wired or wireless networks, including telecommunications, mobile, and cellular phone networks) may perform instruction sequences to practice the present disclosure in coordination with one another.

Mobile device 202 may transmit and receive messages, data and one or more data packets, information and instructions, including one or more programs (i.e., application code) through communication link 322 and network interface component 302. Communication link 322 may be wireless through a wireless data protocol such as Wi-Fi™, 3G, 4G, HDSPA, LTE, RF, NFC, or through a wired connection. Network interface component 302 may include an antenna, either separate or integrated, to enable transmission and reception via communication link 322. Received program code may be executed by processing component 306 as received and/or stored in memory 308, 310, or 312.

FIG. 4 is a flowchart illustrating a method for allowing a user of a mobile device to take actions in conjunction with content displayed on the mobile device, consistent with some embodiments. For the purpose of illustration the method shown in FIG. 4 may be described with reference to any of FIGS. 1a, 1b, 2, and 3. The method shown in FIG. 4 may be embodied in instructions stored on a non-transient, tangible, computer-readable medium that when executed by one or more processors of processing component 316 cause mobile device 202 to perform the illustrated method. As shown in FIG. 4, the method begins when mobile device 202 receives content and a configuration script 224 from advertising content provider 206 (402). The content received from advertising content provider 206 may then be displayed by display component 314 of mobile device 202 (404). According to some embodiments, content displayed comprises one of a video advertisement, a rich-media and an image banner.

One or more processors of processing component 306 may then configure a graphical user interface displaced on display component 314 according to the configuration script (406). According to some embodiments, configuring a graphical user interface may include configuring media player client application 212 and/or mobile device 202 to display on display component 214 a number of user selectable actions that are grouped on the GUI under a number of functional categories, with one or more of the user actions each being associated with an application program executable by the mobile device, and solicit a selection of one of the user selectable actions. Configuring a GUI may also include when execution of the associated application program requires providing information as input to the application program, gathering the information from the mobile device and configuring the information as input data to the application program.

After the GUI has been configured, mobile device 202 may receive a user action (408). According to some embodiments, the user action may be received by display component 314, input component 316, or navigation control 318, or any combination thereof. Processing component 306 may then handle the received user action according to instructions in any of memories 308, 310, and 312 associated with the user action (410).

Software, in accordance with the present disclosure, such as program code and/or data, may be stored on one or more machine readable mediums, including non-transitory machine readable medium, such as any of memories 314, 316, and 318 in mobile device 202. It is also contemplated that software identified herein may be implemented using one or more general purpose or specific purpose computers or application specific integrated circuits (ASICs) and/or computer systems, networked and/or otherwise. Where applicable, the ordering of various steps described herein may be changed, combined into composite steps, and/or separated into sub-steps to provide features described herein.

The examples provided above are exemplary only and are not intended to be limiting. One skilled in the art may readily devise other systems consistent with the disclosed embodiments which are intended to be within the scope of this disclosure. As such, the application is limited only by the following claims.

We claim:

1. A method for allowing a user of a mobile device to take actions in conjunction with content displayed on the mobile device, comprising:
receiving from a content provider the content to be displayed on the mobile device and a configuration script associated with the content, the configuration script specifying a single-page graphical user interface which (a) displays a number of user selectable actions that are grouped on the graphical user interface under a number of functional categories, with one or more of the user actions each being associated with an application program executable by the mobile device; and (b) solicits a selection of one of the user selectable actions;
displaying the content on a video display of the mobile device;
configuring the graphical user interface in accordance with the configuration script; and
handling the action as appropriate on the mobile device in response to the user selecting one of the user selectable actions.

2. The method of claim 1, wherein the configuration script is specified by an XML document.

3. The method of claim 1, wherein configuring the graphical user interface further comprises, when execution of the associated application program requires providing information as input to the application program, gathering the information from the mobile device and configuring the information as input data to the application program.

4. The method of claim 3, wherein the information comprises information selected from the group consisting of pre-filled emails, pre-filled forms, and pre-populated map searches.

5. The method as in claim 1, wherein the functional categories comprises one or more of (a) sharing the content with a second user; (b) responding to the content provider, and (c) interacting with the content provider's content as specified in the configuration script.

6. The method as in claim 1, wherein the content displayed comprises one of a video advertisement, a rich-media and an image banner.

7. An apparatus for allowing a user of a mobile device to take actions in conjunction with content displayed on the mobile device, comprising:
content to be displayed on the mobile device; and
a configuration script associated with the content to be displayed, wherein the configuration script specifies a single-page graphical user interface to be displayed immediately after the content is displayed, wherein the graphical user interface (a) displays a number of user selectable actions grouped on the graphical user interface under a number of functional categories, wherein one or more of the user actions are each associated with an application program executable by the mobile device; (b) solicits a selection of one of the user selectable actions; and (c) invokes execution of the application program associated with the selected user selectable action.

8. The apparatus of claim 7, wherein the configuration script is specified by an XML document.

9. The apparatus of claim 7, wherein the graphical user interface, when the associated application program requires providing information as input, gathers the information from the mobile device and configures the information as input data to the application program.

10. The apparatus of claim 9, wherein the information comprises information selected from the group consisting of pre-filled emails, pre-filled forms, and pre-populated map searches.

11. The apparatus of claim 7, wherein the functional categories comprises one or more of (a) sharing the content with a second user; (b) responding to the content provider, and (3) interacting with the content provider's content as specified in the configuration script.

12. The apparatus of claim 7, wherein the content displayed comprises one of a video advertisement, a rich-media and an image banner.
